(19) United States
(12) Patent Application Publication
(10) Pub. No.: US 2004/0202924 A1
(43) Pub. Date: Oct. 14, 2004

(54) Electrode layer arrangements in an electrochemical device

(75) Inventors: Tao T. Tao, Hopkinton, MA (US); Wei Bai, Westboro, MA (US); Scott Rackey, Bedford, MA (US); Gonghou Wang, Westboro, MA (US)

Correspondence Address: Timothy J. Oyer, Ph.D., Wolf, Greenfield & Sacks, P.C., 600 Atlantic Avenue, Boston, MA, 02210, US

(73) Assignee: Cell Tech Power, Inc., Westboro, MA (US)

(21) Appl. No.: 10/744,602

(22) Filed: Dec. 23, 2003

Related U.S. Application Data
(63) Continuation of application No. PCT/US02/20099, filed on Jun. 25, 2002.
(60) Provisional application No. 60/300,800, filed on Jun. 25, 2001.

(51) Int. Cl. H01M 4/36; B05D 5/12

(52) U.S. Cl. 429/102; 427/126.3

(57) ABSTRACT

The present invention relates to an electrochemical device that can operate either as a fuel cell or a battery, and particularly to a device including an electrode arrangement involving a liquid metal positioned against a layer comprising anodic material. When a fuel is positioned adjacent the layer comprising anodic material, a tri-junction area results in which electrochemical or anode regeneration processes can occur. The layer comprising anodic material can also function as a catalyst, for catalyzing electrochemical reactions, or as a protective layer for the electrode against various degradative processes.

### RELATED APPLICATIONS

This application is a continuation of International Application No. PCT/US02/20099 filed Jun. 25, 2002, which was published under PCT Article 21(2) in English, and claims priority to U.S. Application Serial No. 60/300,800, filed Jun. 25, 2001. Both applications are hereby incorporated by reference.

### FIELD OF INVENTION

The present invention relates to an electrochemical device that can operate either as a fuel cell or a battery. The device features an electrode arrangement involving a liquid metal positioned against a layer comprising anodic material.

### BACKGROUND OF THE INVENTION

In a fuel cell comprising a solid oxide electrolyte, a cathode reduces oxygen to oxygen ions and an anode oxidizes a fuel accompanied by a release of electrons. The oxidized fuel combines with the oxygen ions to counteract a resulting flow of released electrons through an external circuit. The anode is not consumed during operation of the fuel cell. Theoretically, the fuel cell can operate as long as fuel is supplied to the anode.

Electrical output depends on several factors, including the type of fuel used and the operational temperature, as well as the electrode and electrolyte components. To provide a high electrical output, new materials have been devised that can withstand high operational temperatures. Such high temperatures may not be practical for many applications, however. In addition, a combination of currently known materials results in a heavy device, which is not practical for variable load applications. Attempts to improve the performance of fuel cells include the discovery of new materials for anode, electrolyte and cathode components. Each device, however, is generally specific for a certain type of fuel.

In a metal/air battery, a cathode reduces oxygen to oxygen ions in a similar manner to a fuel cell, but the anode itself oxidizes, and this reaction is accompanied by a release of electrons to an external circuit. Thus, the anode is consumed. For charge balance, the oxidized anode reacts with oxygen ions produced by the cathode. The battery does not require fuel in order to generate electricity. The battery, however, has only a defined lifetime as determined by the lifetime of the anode.

Attempts have been made to combine the attributes of a fuel cell and a battery. For example, a device may comprise separate battery and fuel cell components, thus combining the storage capacity of a battery with the longevity of fuel cells. This arrangement, however, only adds to the weight of the device.

Much effort has been made, and continues to be made, to improve the performance of fuel cells and batteries, particularly for mobile applications where lightweight components and increased power output are essential.

### SUMMARY OF THE INVENTION

In one embodiment, the present invention is directed to an electrochemical device comprising an anodic material positioned between an electrolyte and a liquid metal.

In another embodiment, the present invention is directed to an electrochemical device comprising an anodic layer comprising anodic material, the anodic layer being positioned between an electrolyte layer and a liquid metal.

In another embodiment, the present invention is directed to an electrochemical device comprising a catalyst positioned adjacent to an electrolyte layer, the catalyst further contacting a liquid metal.

In another embodiment, the present invention is directed to an anode comprising a liquid metal positioned adjacent a ceramic having an ionic conductivity of at least about 0.01 S/cm and an electrical conductance of at least about 0.001 S/cm.

In another embodiment, the present invention is directed to a method of forming a layer in an electrochemical device comprising providing an anode comprising a liquid first metal such that it is in contact with an electrolyte and depositing a portion of the first metal on the electrolyte as a first metal oxide.

In another embodiment, the present invention is directed to an electrochemical device comprising an anode and a current collector comprising a liquid metal in electronic communication with the anode.

Other advantages, novel features, and objects of the invention will become apparent from the following detailed description of the invention when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

FIG. 1 shows a schematic cross-section of a prior art fuel cell;

FIG. 2 shows a schematic cross-section of an exemplary device of the present invention, featuring an anodic layer positioned between an electrolyte layer and a liquid metal.

FIG. 3 shows an expanded view of the schematic cross-section of the device of FIG. 2, featuring a tri-junction area;

FIG. 4 shows a schematic cross-section of an exemplary device of the present invention, featuring an anodic layer comprising a monolith in which pores of the monolith include anodic material;

FIG. 5 shows a schematic cross-section of an exemplary device of the present invention, featuring particles or blocks comprising anodic material positioned on an electrolyte layer and further contacting a liquid metal;

FIG. 6 shows an expanded view of the schematic cross-section of the device of FIG. 5 featuring areas involving anodic particles or blocks, electrolyte, fuel and liquid metal surfaces;

FIG. 7 is a photocopy of a photomicrograph of one aspect of the present invention;

FIG. 8 is a graph of relative intensity versus emitted X-ray energy in eV;

FIG. 9 is a photocopy of a photomicrograph of one aspect of the present invention; and

FIG. 10 is a graph of relative intensity versus emitted X-ray energy in eV.

### DETAILED DESCRIPTION

Various aspects of the present invention relate to electrode layer arrangements in an electrochemical device. In one embodiment, electrochemical devices of the present invention are capable of converting chemical energy, via an electrochemical reaction, into electrical energy to produce an electrical output. Examples of electrochemical devices include a fuel cell and a battery. Other examples include an oxygen purifier and an oxygen sensor.

In one embodiment, the electrochemical device has a dual-mode capability in that the device can operate both as a fuel cell and as a battery. Thus, not only is the device capable of oxidizing a fuel source and releasing electrons (e.g., as in a fuel cell), but the device can store electricity to be used upon connection to a load (e.g., as in a battery).

An advantage of this dual-mode capability can be illustrated by the following scenario. A typical prior art fuel cell can produce power so long as there is a supply of fuel. When the fuel supply is exhausted, the electrical output ceases almost instantaneously. This situation can be disastrous especially when a fuel cell device is being used for variable load applications in which replacement fuel is not immediately available. To circumvent this problem, certain prior art fuel cell devices have been provided with a battery back-up. The addition of a separate battery, however, adds weight and complexity to the fuel cell device, which is undesirable especially for variable load applications.

The use of batteries as a sole source of power also has its disadvantages. In a typical battery, electrical power is generated at the expense of anode consumption, as the anode is consumed to release electrons. This anode consumption causes batteries to have a defined lifetime which is dictated, in large part, by the lifetime of the anode. To circumvent this problem, certain prior art electrically rechargeable batteries have been developed in which an input of electrons from an outside source reduces the consumed anode and restores the anode to its initial state. However, an external power source is required for electric recharging.

In contrast, the device of the present invention is capable of switching between “battery mode” and “fuel cell mode.” For example, if the fuel supply is exhausted, the device can continue to generate electricity while operating in battery mode thereby eliminating the need for an external battery back-up. Furthermore, when the fuel supply is replenished the device in battery mode can switch back to fuel cell mode if so desired.

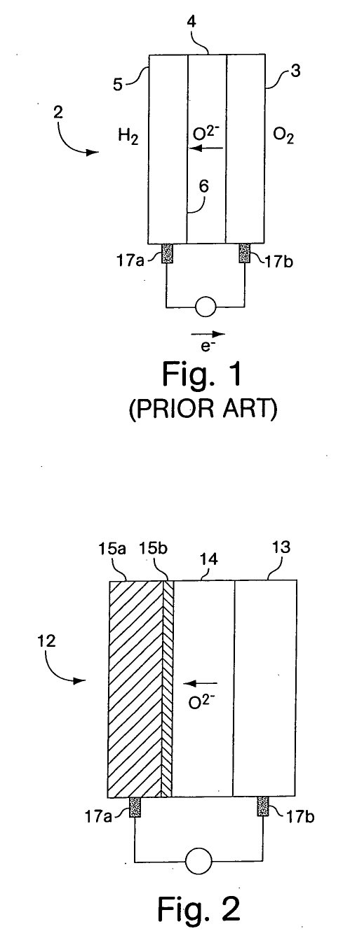

FIG. 1 shows a schematic cross-section of a prior art fuel cell 2 including electrodes and electrolyte layers comprising solid state materials. In FIG. 1 cathode layer 3 of fuel cell 2 is positioned adjacent electrolyte layer 4. At cathode 3, oxygen is oxidized to oxygen ions with the addition of electrons from cathode 3, as represented by the electrochemical half reaction shown in eq. 1:

½O₂+2 e⁻→O²⁻ (1)

Electrolyte layer 4 is positioned between and adjacent cathode layer 3 and anode layer 5. Electrolyte 4 allows migration of ions between the electrodes. After oxygen is ionized at the cathode (i.e. eq. 1 occurs), oxygen anions migrate through electrolyte layer 4 to anode 5 at interface 6, i.e. the interface between electrolyte 4 and anode 5. At interface 6, the electricity-generating reaction occurs. As the vast majority of prior art fuel cells operate on hydrogen fuel, the electricity-generating reaction of the oxidation of hydrogen fuel and recombination with oxygen anions:

H₂+O²⁻→H₂O+2 e⁻ (2)

The reaction of eq. 2 releases two electrons per mole of hydrogen. Fuel cell 2 can theoretically run indefinitely so long as there is a supply of fuel. When the fuel supply is exhausted, however, electricity ceases to be produced.

One aspect of the present invention provides an electrochemical device comprising an anodic material positioned between an electrolyte and a liquid metal.

In one embodiment, the present invention provides an electrochemical device comprising an anodic layer comprising anodic material. The anodic layer is positioned between an electrolyte layer and a liquid metal. The use of the liquid metal can allow the electrochemical device to operate both as a fuel cell and as a battery, as discussed more fully in detail below.

FIG. 2 shows a schematic cross-section of an example of an electrochemical device of the present invention. In FIG. 2., electrochemical device 12 features cathode layer 13 positioned adjacent electrolyte layer 14 which is further positioned adjacent layer 15b. Layer 15b comprises an anodic material. Device 12 further features liquid metal 15a positioned adjacent layer 15b on the opposite side of electrolyte layer 14.

“Anodic material” refers to any material capable of functioning as an anode in a fuel cell or a battery. Examples of “anodic material” include metals such as main group metals, transition metals, lanthanides, actinides. Other examples include ceramics, or ceramics doped with any metal listed previously. Examples of ceramics include cerium oxide (CeO₂), indium oxide (In₂O₃), tin oxide, vanadium carbide and vanadium oxide (V₂O₅). The ceramic can include more than one metal ion. Examples include copper/cerium oxides or tin/indium oxides. In one embodiment, the dopant metal (i.e. the metal ion doped in the oxide) is present in an amount ranging from trace amounts to about 50 mol %. In other embodiments, the dopant metal is present in an amount from about 2 mol % to about 50 mol %, or from about 20 mol % to about 30 mol %. Examples include cerium doped YSZ, gadolinium doped cerium oxides and samarium doped cerium oxides. In one embodiment, “anodic material” refers to any material known in the art as capable of functioning as an anode in a solid oxide fuel cell. An example of such an anode includes nickel in YSZ.

A “liquid” is a material which exhibits flow properties. In one embodiment, a liquid is a material which exhibits a tendency to flow in response to an applied force under given operating conditions of temperature and pressure. Liquids generally have little or no tendency to spontaneously disperse. Preferably, materials which flow within a time scale that is not visually perceptible by the human eye are generally excluded from this definition. In one embodiment, liquid metal 15a is a liquid at temperatures for which the device is operable.

One advantage of a device of this aspect of the present invention is the provision of a tri-junction area including the liquid metal, for providing a variety of electrochemical reactions. This device also includes an additional interface between the anode and the electrolyte, as in prior art fuel cells, for producing electricity via a reaction similar to that represented by eq. 2. The increase in electrochemical reaction types allows: (1) operation of the device as a fuel cell; (2) operation of the device as a battery; (3) chemical recharging of the anode; (4) increased efficiency of power output; and (5) capability to operate with multiple fuels, including fuels in the liquid phase, gas phase or solid phase.

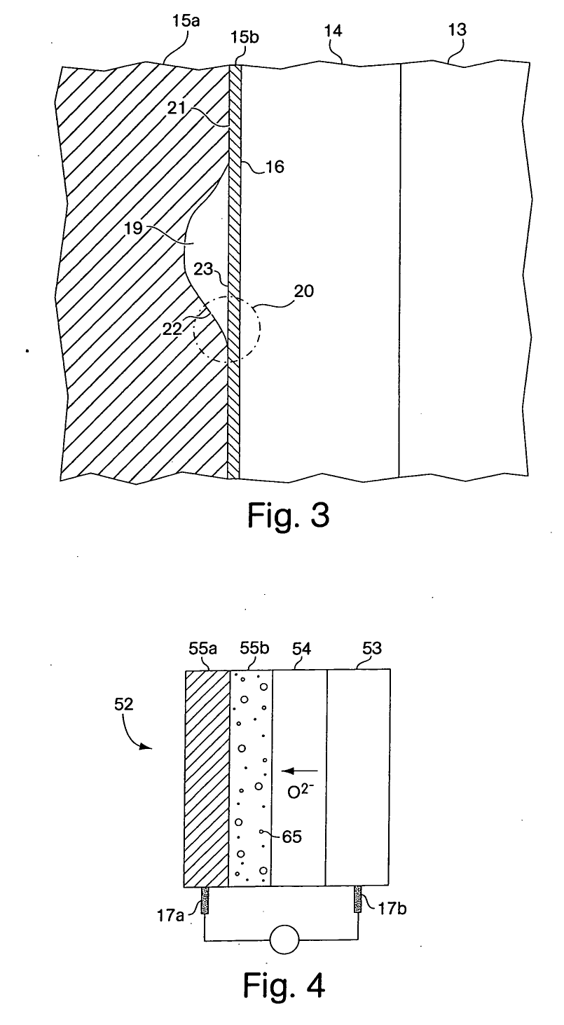

For example, FIG. 3 shows an expanded cross-section of device 12 of FIG. 2. Interface 16 represents the interface between electrolyte 14 and layer 15b, analogous to interface 6 of prior art device 2 in FIG. 1. At interface 16, oxygen anions can combine with fuel to release electrons involving a reaction similar to that shown in eq. 2, i.e. operation as a fuel cell.

FIG. 3 further shows the cross-section of device 12 at a moment in time when fuel 19 is positioned adjacent layer 15b. Fuel 19 can be a solid (comprising particles or blocks of any size), a liquid or a gas. Fuel 19 can be dispersed throughout liquid metal 15a as bubbles (gas), liquid droplets, or blocks or particles of solid fuel. Positioning of fuel 19 along layer 15b creates new interfaces along which electrochemical reactions can occur. Area 20 highlights a tri-junction area of liquid metal 15a, layer 15b and fuel 19. A variety of electrochemical reactions can occur in tri-junction area 20.

In one embodiment, layer 15b comprises a material capable of transporting oxygen ions through layer 15b. In this embodiment, oxygen ions are not only capable of reacting with fuel along interface 16, but can migrate throughout layer 15b, unlike certain prior art fuel cells, i.e. anodic layer 15b has an ionic conductivity. Oxygen ions can be present along interface 21, which represents an interface between liquid metal 15a and 15b, or along interface 23, which represents an interface between anodic layer 15b and fuel 19. The presence of oxygen ions along interfaces 21 or 23 provides the possibility of electricity-generating reactions such as that represented in eq. 2, i.e. operation as a fuel cell. For example, along interfaces 21 or 23, fuel can react with oxygen ions at the surface of anodic layer 15b. Thus, an anodic layer having ionic conductivity effectively increases the surface area along the anodic layer by which electricity-generating reactions can occur, thus increasing the efficiency of the power output. In one embodiment, the material of layer 15b has an ionic conductivity of at least about 0.01 S/cm, preferably at a temperature in which the device is operable.

At interface 21, liquid metal 15a directly contacts layer 15b and is not exposed to fuel 19, unlike interface 23. In the absence of exposure to fuel, liquid metal 15a can be oxidized via a reaction with oxygen anions at the interface to form a metal oxide, as shown in eq. 3:

x M+n O²⁻→x Moₙ+2n e⁻ (3)

where “x” and “n” represent the number of moles of liquid metal “M” and oxygen ions that migrated from electrolyte 13, respectively. Thus, the device can generate electricity like a battery in which the liquid metal, acting as an electrode, is consumed to form a metal oxide “MOₙ”. In this embodiment, liquid metal layer 15a functions as an anode and layer 15b functions as an extended electrolyte. Even in the absence of fuel exposed to the device, the device can continue to generate electricity, which is invaluable for mobile applications.

The anodic layer (layer 15b) can also comprise a metal. In one embodiment, the liquid metal is more easily oxidized than the metal in the anodic layer, i.e., the liquid metal has a lower oxidation potential. This allows any battery-mode operation (i.e. metal oxidation to release electrons) to be focused on the liquid metal via formation of metal oxide MOₙ along interface 21 accompanied by a release of electrons. The metal oxide formed is typically a solid, and formation of this solid along interface 21 reduces a surface area in which electricity-generating reactions can occur, thus reducing the overall efficiency of the device. The liquid metal provides an advantage in that it can be stirred or agitated to remove the solid metal oxide physically from interface 21. Moreover, the solid metal oxide can be dispersed within the liquid metal, producing a clean liquid metal surface for undertaking further reactions. To focus the battery mode operation on the liquid metal, the device can be operated at a sufficiently high voltage to prevent oxidation of the metal in the anodic layer, and at a sufficiently low voltage to allow oxidation of the liquid metal.

In other embodiments, the device is operated at a sufficiently high voltage resulting in oxidation of both the liquid metal and metal in the anodic layer. In these embodiments, stirring or agitation of the liquid metal may be sufficient to remove any solid metal oxide formed from interface 21.

As discussed previously, the formation of metal oxide as represented by eq. 3 can generate solid metal oxide along the surface of metal 15a. In one embodiment, the metal oxide is capable of being chemically recharged back to its metallic state, or to a reduced state. For example, the metal oxide can be reduced to a metal by reaction with a chemical reductant. In one embodiment, the chemical reductant is the fuel, and the reduction reaction is represented by eq. 4:

x MOₙ+fuel→M+aCOₓ+bNO_{y}+cSO_{z}+dH₂O+(optionally other oxidation products) (4)

This reaction will typically occur at a metal oxide/fuel interface, such as interface 22 or interface 23 in FIG. 3, where fuel 19 contacts a metal oxide formed on the surface of liquid metal 15a or layer 15b. “MOₙ” in eq. 4 represents the metal oxide which provides oxygen anions, and “M” represents a reduced state of MOₙ, e.g. a metallic state. Eq. 4 is intended to represent some of the various possible products resulting from the oxidation of the fuel. The coefficients a, b, c, d, x, y, and z can be the same or different and each are greater than or equal to zero and their values depend on the type of fuel used, and at least one of a, b, c, d, x, y, and z will be greater than zero. The coefficient “n” is greater than 0. The fuel may comprise a combination of “a” carbon atoms and/or “b” nitrogen atoms and/or “c” sulfur atoms and/or d hydrogen atoms, etc. For example, COₓ can represent CO₂, CO or a mixture thereof. If hydrogen is the fuel, water is the sole oxidation product. Not all possible oxidation products are represented by eq. 4 and depending on the composition of the fuel, those of ordinary skill in the art can determine the resulting oxidation product.

Chemical recharging provides an advantage for situations where the device in this aspect of the invention is operated in battery mode, where at least a portion of the liquid metal is consumed and electrons are released. Chemical recharging can be initiated by exposing the portion of the consumed metal to a chemical reductant resulting in that portion being reduced to a more reduced state, such as the initial oxidation state. Thus, it is the chemical reductant, not electricity (as in prior art devices), that, at least in part, recharges the liquid metal. In one embodiment, the chemical reductant alone causes recharging of the liquid metal. In another embodiment, a combination of chemical and electrical recharging results in restoration of the liquid metal. An advantage of chemical recharging is the provision of the recharging species, (i.e., the chemical) located within the device itself. Thus no external recharging species is needed. This feature is particularly desired for use in areas where electrical power sources for electrical recharging may not be readily available.

Certain metals are capable of existing in more than two oxidation states or in non-integral oxidation states. A metal or alloy comprises metals having a neutral charge. Certain metals can be oxidized to one or more oxidation states, any one of these states being of a sufficient electrochemical potential to oxidize the fuel. Conversely, if that metal is oxidized to its highest oxidation state, it can be reduced to more than one lower oxidation state (at least one having a higher oxidation state than neutral) where the metal is capable of functioning in any of these states. Alternatively, a metal oxide or mixed metal oxide may collectively oxidize fuel where metal ions are reduced by formal non-integer values.

In one embodiment, the chemical reductant is the fuel itself. An advantage of this embodiment can be illustrated with the previous scenario, in which the device is operating in battery mode. Upon depletion of the anode, the device can convert back to fuel cell mode where the fuel is consumed to produce electricity. In addition, the fuel can chemically recharge the oxidized metal to its initial state via a chemical reaction. A portion of the fuel reduces the metal and another portion of the fuel is oxidized to generate electricity. When the liquid metal is restored (or a portion restored) to a reduced state, such as its initial state, the device regains its internal “battery back-up” for future emergency situations. The use of the fuel itself as a recharging source provides another advantage in that the device automatically contains the recharging source, thus eliminating the need to store additional chemicals into the device. In other embodiment, however, it may be desired to incorporate another chemical reductant specifically for recharging the liquid metal and having sufficient electrochemical activity to carry out this function.

In one embodiment, the chemically rechargeable device can be configured to allow recharging with electricity in addition to the chemical recharging capability. For certain liquid metals and certain fuel types, it may be more feasible to recharge electrically if such an electrical power supply is readily available. For mobile applications, it is preferred that the liquid metal is chemically rechargeable as well for the reasons described previously, e.g. eliminate need to carry a separate battery back-up for a lighter device.

In one embodiment, the liquid metal can be a pure metal or can comprise an alloy comprising two or more metals. Upon consumption of a portion of the liquid metal, the portion of the anode is oxidized to form a metal oxide. A mixed metal oxide can be formed in the case where the anode is an alloy. In one embodiment, the metal has a standard reduction potential greater than −0.70 V versus the Standard Hydrogen Electrode (determined at room temperature). These values can be obtained from standard reference materials or measured by using methods known to those of ordinary skill in the art. In another embodiment, where the liquid metal is an alloy, all metals preferably have a standard reduction potential greater than −0.70V versus the Standard Hydrogen Electrode. Balancing the various electrochemical potential requirements can be determined by those of ordinary skill in the art. In certain embodiments, an alloy can be used where at least one of the metals does not have a standard reduction potential greater than −0.70V, but is included in the alloy to enhance flow properties, consistency, or other properties not related to electrochemical potential. In other embodiments, the liquid metal can include non-metals (or metals that do not contribute to the electrochemical reaction) to enhance flow properties, consistency, or other properties not related to electrochemical potential.

In one embodiment, the liquid metal comprises a metal or alloy comprising at least one of a transition metal, a main group metal, an alkaline metal, an alkaline earth metal, a lanthanide, an actinide and combinations thereof. In another embodiment, the liquid metal comprises material such as copper, molybdenum, mercury, iridium, palladium, antimony, rhenium, bismuth, platinum, silver, arsenic, rhodium, tellurium, selenium, osmium, gold, lead, germanium, tin, indium, thallium, cadmium, gadolinium, chromium nickel, iron, tungsten, cobalt, zinc, vanadium or combinations thereof. For example, the liquid metal can comprise a pure metal such as antimony, indium, tin, bismuth, mercury and lead. In another embodiment, the liquid metal comprises an alloy of at least one element such as copper, molybdenum, mercury, iridium, palladium, antimony, rhenium, bismuth, platinum, silver, arsenic, rhodium, tellurium, selenium, osmium, gold, lead, germanium, tin, indium, thallium, cadmium, gadolinium, chromium nickel, iron, tungsten, vanadium, manganese, cobalt, zinc, cerium, scandium, beryllium, gallium and combinations thereof. Examples of alloys include 5% lead with reminder antimony, 5% platinum with reminder antimony, 5% copper with reminder indium, 20% lead, 10% silver, 40% indium, 5% copper.

The liquid metal allows the device to operate on hydrogen or fuels other than hydrogen. “Operate on fuels” as referred herein involves the direct oxidation of the fuels themselves. This is distinguished from prior art devices which use fuels other than hydrogen (e.g. methanol, methane) but reform these fuels to extract hydrogen which is the actual fuel used to operate the device. Fuels that can be used in accordance with one aspect of the invention include fuels comprising a carbonaceous material include conductive carbon, graphite, quasi-graphite, coal, coke, charcoal, fullerene, buckminsterfullerene, carbon black, activated carbon, decolorizing carbon, a hydrocarbon, an oxygen-containing hydrocarbon, carbon monoxide, fats, oils, a wood product, a biomass and combinations thereof. Examples of a hydrocarbon fuel include saturated and unsaturated hydrocarbons, aliphatics, alicyclics, aromatics, and mixtures thereof. Other examples of a hydrocarbon fuel include gasoline, diesel, kerosene, methane, propane, butane, natural gas and mixtures thereof. Examples of oxygen-containing hydrocarbon fuels include alcohols which further include C₁-C₂₀ alcohols and combinations thereof. Specific examples include methanol, ethanol, propanol, butanol and mixtures thereof. However, almost all oxygen-containing hydrocarbon fuels capable of being oxidized by the anode materials disclosed herein can be used so long as the fuel is not explosive or does not present any danger at operating temperatures.

Gaseous fuels such as hydrogen and SynGas (a mixture of hydrogen and carbon monoxide) can also be used in certain embodiments of the invention.

In one embodiment, layer 15b is electronically conducting as well as comprising an anodic material. Examples include cerium oxide or indium oxide/tin oxide (In₂O₃/SnO₂). This arrangement has the advantage of maximizing the surface area of anodic material capable of electricity-producing reactions followed by migration of electronic charge to the load. Referring back to FIG. 3, if layer 15b were not electronically conducting, any portion of a surface of layer 15b which is coated with a metal oxide and interfaces with the fuel cannot extract electricity and thus, an electricity generating reaction cannot occur in this portion of the surface of layer 15b. Thus, efficiency of the cell decreases due to the lower surface area of active layer 15b.

In contrast, electronically conducting layer 15b can conduct electronic charge to layer 15a and further allowing electrons to migrate to the load. In one embodiment, the anodic layer has an electronic conductance greater than or equal to that of the electrolyte layer. Preferably, layer 15b has an electronic conductance (i.e. capable of conducting electronic charge) of at least about 0.001 S/cm, and more preferably having an electronic conductance at least that of a metal. In one embodiment, layer 15b can have any of the listed conductance values at an operable temperature of the device. Examples of such electronic conducting materials include conducting ceramics or ceramics doped with any metals listed previously.

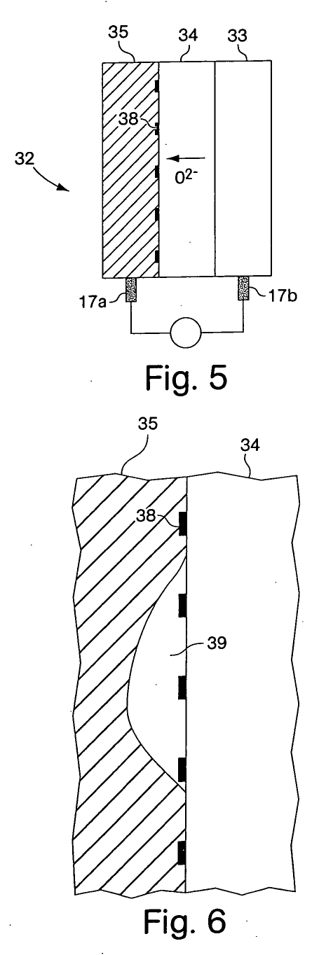

In another embodiment, a layer comprising the anodic material (“anodic layer”) can also include material not capable of acting as an anode. FIG. 4 shows another example of a device of the invention, in which layer 55b comprises material including a plurality of pores 65. The size of pores 65 in FIG. 4 has been greatly exaggerated for illustrative purposes only. Preferably, pores 65 form a network of interconnected channels, and layer 55b comprises a monolith. The monolith can be inert with respect to electrochemical reactivity (i.e. it does not act as an anode). The anodic material in this embodiment can be provided by including particulate anodic material within pores 65, preferably in a sufficient amount to result in a continuous network of anodic material throughout layer 55b and particularly a continuous network comprising anodic material having a length spanning a distance between electrolyte 54 and liquid metal 55a. Preferably, the anodic material is inert to reaction with the monolith. In one embodiment, the anodic material comprises a metal. Examples of such materials include “cermets” such as Ni/YSZ and Ru/YSZ.

In one embodiment, the anodic layer comprises a material capable of transporting oxygen, i.e. oxygen-containing species, through an anodic layer/electrolyte interface. The anodic layer may be capable of further transporting oxygen through the anodic layer, or oxygen may be prevented from migrating through the anodic layer so long as the oxygen passes through the anodic layer/electrolyte interface. In either the electrolyte or the anodic layer, oxygen ions can be reduced to an oxygen atom or oxygen molecules. Thus, “oxygen” or “oxygen-containing species” includes oxygen anions, oxygen atoms and oxygen molecules. Preferably a total oxygen flux through the anodic layer/electrolyte interface is at least about 10¹⁵ oxygens/s·cm². In one embodiment, this oxygen flux results in a power output of 0.001 W/cm². In one embodiment, the total oxygen flux comprises primarily oxygen anions.

In one embodiment, the anodic layer is a “dense” layer, i.e. the anodic layer can allow transportation of oxygen ions but not oxygen molecules. Such materials are well known in the art. Examples include scandia-stabilized zirconia and india-stabilized zirconia.

In one embodiment, the anodic layer comprises a non-continuous layer, i.e. the anodic layer does not have to completely cover a surface of the electrolyte layer, and isolated portions of anodic material can be positioned adjacent the electrolyte layer. In one embodiment, the anodic layer can comprise particulate anodic material positioned adjacent the electrolyte layer, or blocks of anodic material positioned adjacent the catalyst layer. FIG. 5 shows an example of an electrochemical device 32 comprising cathode 33 positioned adjacent electrolyte layer 34. Anodic layer 38 is positioned on electrolyte layer 34. Although anodic layer 38 is depicted schematically as a uniform series of blocks, it is readily understood that anodic layer 38 can also be positioned non-uniformly and that the blocks can also represent a distribution of particulate anodic material. Liquid metal layer 35 is depicted as a continuous layer contacting both anodic layer 38 and electrolyte 34. In one embodiment, liquid metal layer 35 can contact only anodic layer 38 and not electrolyte 34.

FIG. 6 shows an expanded view of the schematic cross-section of the device of FIG. 5 featuring multi-junction areas involving a layer comprising anodic material, electrolyte, fuel and liquid metal surfaces. At the fuel/electrolyte, fuel/liquid metal and electrolyte/liquid metal interfaces, the reactions described previously in relation to FIGS. 2 and 3 can occur.

Another aspect of the present invention provides an electrochemical device comprising an anode and a current collector in electronic communication with the anode. The current collector comprises a liquid metal. FIG. 2 also shows current collector 17a to draw electronic charge from the anodic reactions (current collector 17b is in electronic communication with cathode 13). In one embodiment, liquid metal 15a can also function as a current collector and current collector 17a can be absent from the system.

Another aspect of the present invention provides an electrochemical device, comprising a catalyst positioned adjacent to an electrolyte layer, the catalyst further contacting a liquid metal. In one embodiment, the catalyst comprises a catalytic layer. Referring back to FIG. 2, layer 15b can comprise a catalytic layer. A “catalytic layer” is capable of at least catalyzing any electricity-generating reaction, i.e. an anodic reaction. Examples of such reactions include the reactions represented by eqs. 2, 3 and 4. In this embodiment, layer 15b functions as both an anode and a catalyst. In this embodiment, liquid metal 15a functions as the anode.

In one embodiment, the “catalyst positioned adjacent the electrolyte layer” includes catalyst present as a non-continuous layer. The catalyst can comprise particulate catalyst positioned adjacent the electrolyte layer, or blocks of catalyst positioned adjacent the catalyst layer. Referring back to FIG. 5, electrochemical device 32 can comprise cathode 33 positioned adjacent electrolyte layer 34 further positioned adjacent anodic layer 38 which can also function as a catalyst.

Examples of anodic material which can function as a catalyst include copper oxide/cerium oxide (CuO/CeO₂) and copper oxide/cerium oxide/YSZ (CuO/CeO₂/YSZ).

Referring back to FIG. 2, layer 15b can also function to protect the electrolyte from degradative processes, such as physical degradation, leaching of metal ions, oxidation, etc. Examples of a protective layer include titanium oxide enhanced YSZ (TiO₂/YSZ), aluminum oxide/YSZ (Al₂O₃/YSZ), scandia stabilized zirconia, india stabilized zirconia, beryllium oxide stabilized zirconia, gallium oxide stabilized zirconia, tin oxide and indium oxide (In₂O₃).

In one embodiment, the device is operable, with the anode in a liquid state, at a temperature of less than about 1500° C., preferably at a temperature of less than about 1300° C., more preferably less than about 1200° C., even more preferably less than about 1000° C., and even more preferably less than about 800° C. By “operable”, it is meant that the device is able to generate electricity, either as a fuel cell or as a battery with the anode in a liquid state, and the anode may not necessarily be a liquid at room temperature. It is understood by those of ordinary skill in the art that anodic temperature can be controlled by selection of anode materials or in the case of an alloy, composition and percentages of the respective metal components, i.e., composition can affect a melting point of the anode. Other exemplary operating temperature ranges include a temperature between about 300° C. to about 1500° C., between about 500° C. to about 1300° C., between about 500° C. to about 1200° C., between about 500° C. to about 1000° C., between about 600° C. to about 1000° C., between about 700° C. to about 1000° C., between about 800° C. to about 1000° C., between about 500° C. to about 900° C., between about 500° C. to about 800° C., and between about 600° C. to about 800° C.

In one embodiment, the cathode is a solid state cathode. Examples of solid state cathodes include a metal oxide and a mixed metal oxide. Specific examples include tin-doped In₂O₃, aluminum-doped zinc oxide and zirconium-doped zinc oxide. Another example of a solid state cathode is a perovskite-type oxide having a general structure of ABO₃, where “A” and “B” represent two cation sites in a cubic crystal lattice. A specific example of a perovskite-type oxide has a structure LaₓMn_{y}AₐB_{b}C_{c}O_{d} where A is an alkaline earth metal, B is selected from the group consisting of scandium, yttrium and a lanthanide metal, C is selected from the group consisting of titanium, vanadium, chromium, iron, cobalt, nickel, copper, zinc, zirconium, hafnium, aluminum and antimony, x is from 0 to about 1.05, y is from 0 to about 1, a is from 0 to about 0.5, b is from 0 to about 0.5, c is from 0 to about 0.5 and d is between about 1 and about 5, and at least one of x, y, a, b and c is greater than zero. More specific examples of perovskite-type oxides include LaMnO₃, La_{0.84}Sr_{0.16}MnO₃, La_{0.84}Ca_{0.16}MnO₃, La_{0.84}Ba_{0.16}MnO₃, La_{0.65}Sr_{0.35}Mn_{0.8}Co_{0.2}O₃, La_{0.79}Sr_{0.16}Mn_{0.85}Co_{0.15}O₃, La_{0.84}Sr_{0.16}Mn_{0.8}Ni_{0.2}O₃, La_{0.84}Sr_{0.16}Mn_{0.8}Fe_{0.2}O₃, La_{0.84}Sr_{0.16}Mn_{0.8}Ce_{0.2}O₃, La_{0.84}Sr_{0.16}Mn_{0.8}Mg_{0.2}O₃, La_{0.84}Sr_{0.16}Mn_{0.8}Cr_{0.2}O₃, La_{0.6}Sr_{0.35}Mn_{0.8}Al_{0.2}O₃, La_{0.84}Sc_{0.16}MnO₃, La_{0.84}Y_{0.16}MnO₃, La_{0.7}Sr_{0.3}CoO₃, LaCoO₃, La_{0.7}Sr_{0.3}FeO₃, and La_{0.5}Sr_{0.5}Co_{0.8}Fe_{0.2}O₃.

Other examples of solid state cathodes include LaCoO₃, LaFeO₃, LaCrO₃, and a LaMnO₃-based perovskite oxide cathode, such as La_{0.75}Sr_{0.25}CrO₃, (La_{0.6}Sr_{0.4})_{0.9}CrO₃, La_{0.6}Sr_{0.4}FeO₃, La_{0.6}Sr_{0.4}CoO₃ or Ln_{0.6}Sr_{0.4}CoO₃, where Ln can be any one of La, Pr, Nd, Sm, or Gd.

Alternatively, the cathode can comprise a metal. Exemplary metal cathodes include platinum, palladium, gold, silver, copper, rhodium, ruthenium, rhenium, iridium, osmium and combinations thereof.

The electrolyte allows conduction of ions between the cathode and anode. The electrolyte allows migration of oxygen ions from the cathode to the anode. In one embodiment, the electrolyte is a solid state electrolyte. Example solid state electrolytes include a metal oxide and mixed metal oxides.

An example of a solid state electrolyte is an electrolyte having a formula (ZrO₂)(HfO₂)ₐ(TiO₂)_{b}(Al₂O₃)_{c}(Y₂O₃)_{d}(MₓO_{y})ₑ where a is from 0 to about 0.2, b is from 0 to about 0.5 c is from 0 to about 0.5, d is from 0 to about 0.5, x is greater than 0 and less than or equal to 2, y is greater than 0 and less than or equal to 3, e is from 0 to about 0.5, and M can be an element such as calcium, magnesium, manganese, iron, cobalt, nickel, copper, and zinc, gallium, beryllium, thorium (Th), scandium, indium, chromium, tin, cerium, ytterbium, gadolinium, lead. More specifically, examples of solid state electrolytes include (ZrO₂), (ZrO₂)(Y₂O₃)_{0.08}, (ZrO₂)(HfO₂)_{0.02}(Y₂O₃)_{0.08}, (ZrO₂)(HfO₂)_{0.02}(Y₂O₃)_{0.05}, (ZrO₂)(HfO₂)_{0.02}(Y₂O₃)_{0.08}(TiO₂)_{0.10}, (ZrO₂)(HfO₂)_{0.02}(Y₂O₃)_{0.08}(Al₂O₃)_{0.10}, (ZrO₂)(Y₂O₃)_{0.08}(Fe₂O₃)_{0.05}, (ZrO₂)(Y₂O₃)_{0.08}(CoO)_{0.05}, (ZrO₂)(Y₂O₃)_{0.08}(ZnO)_{0.05}, (ZrO₂)(Y₂O₃)_{0.08}(NiO)_{0.05}, (ZrO₂)(Y₂O₃)_{0.08}(CuO)_{0.05}, (ZrO₂)(Y₂O₃)_{0.08}(MnO)_{0.05}, ZrO₂CaO and (ZrO₂)_{0.88}(Sc₂0₃)_{0.11}, Al₂O₃)_{0.01}.

Other examples of solid state electrolytes include a CeO₂-based perovskite, such as Ce_{0.9}Gd_{0.1}O₂ or Ce₁₋ₓGdₓO₂ where x is no more than about 0.5; lanthanum-doped ceria, such as (CeO)₁₋ₙ(LaO₅)ₙ, where n is from about 0.01 to about 0.2; a LaGaO₃-based perovskite oxide, such as La₁₋ₓAₓGa_{1-y}B_{y}O₃ where A can be Sr or Ca, B can be Mg, Fe, Co and x is from about 0.1 to about 0.5 and y is from about 0.1 to about 0.5 (e.g. La_{0.9}Sr0_{.1}Ga_{0.8}Mg_{0.2}O₃); a PrGaO₃-based perovskite oxide electrolyte, such as Pr_{0.93}Sr_{0.07}Ga_{0.85}Mg_{0.15}O₃ or Pr_{0.93}Ca_{0.07}Ga_{0.85}Mg_{0.15}O₃; and a Ba₂In₂O₅-based perovskite oxide electrolyte, such as Ba₂(In₁₋ₓGaₓ)₂O₅ or (Ba₁₋ₓLaₓ)In₂O₅, where is x is from about 0.2 to about 0.5.

In some embodiments, electrolyte materials may also function as anodic layers. For example, certain electrolytes may become electronically conductive and anodically active at relatively high temperatures. Such electrolyte materials may function as an anodic layer in electrochemical devices operating at appropriate temperatures. An electronically nonconductive electrolyte layer is preferred to be used in such embodiments to inhibit short circuiting of the cell through the electrolyte. One example of an electrolyte material that may also function as an anodic layer is Ce_{0.08}Y_{0.2}O₂.

An anodic layer may be constructed in any manner that produces a suitable anodic layer and may vary with the type of anodic layer to be formed and its purpose. For example, in one embodiment where the anodic layer is a metal oxide, it may be possible to deposit the anodic layer onto the electrolyte out of the anode. In one embodiment, the anode comprises one or more metals whose oxides, or a mixture thereof, are suitable for use as an anodic layer. In such an embodiment, an anodic layer may be allowed to form by running the electrochemical device as a battery and the layer may be maintained by not fully recharging the cell during subsequent fuel cell operation. For example, as described above, formation of metal oxide may be controlled by controlling the operating voltage of the electrochemical device. Accordingly, the device may be operated at a first voltage to deposit an anode layer and a second voltage in typical use.

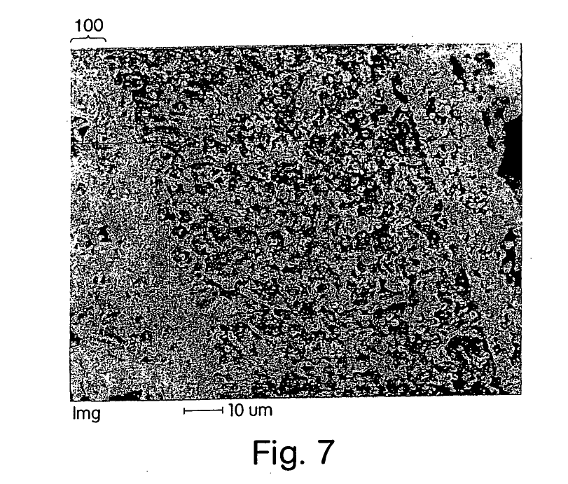

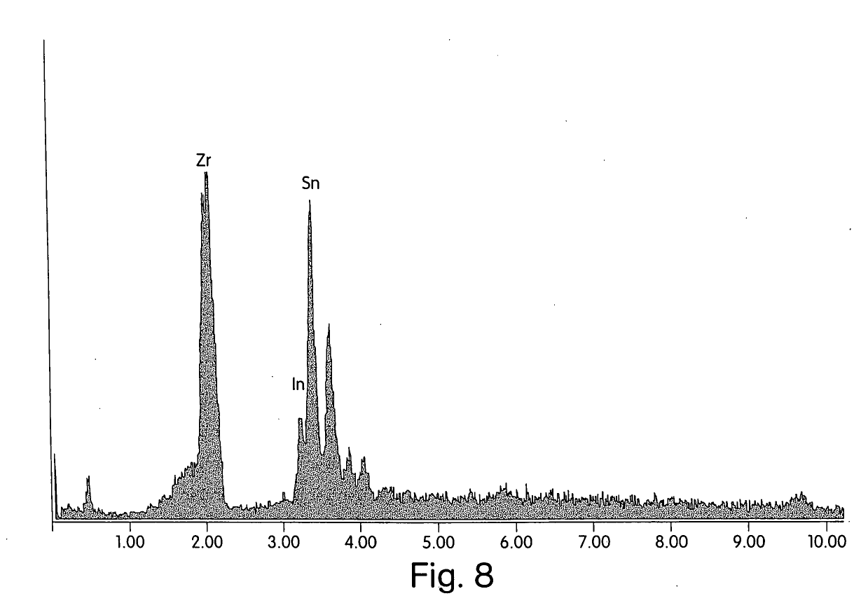

In certain embodiments where the anode layer is to comprise a metal oxide deposited from the anode, it may be possible to selectively deposit particular metal oxides from an anode comprising an alloy. Accordingly, it may be possible to provide a relatively small amount of a metal with the anode and to deposit that metal out of the anode as the metal oxide anode layer. In one such embodiment, the differing voltages at which varying metals oxidize may be used to provide deposition selectivity. For example, a second metal that oxidizes at a higher voltage may be added to an anode comprising a first metal that oxidizes at a lower voltage. In this example the electrochemical device containing the anode could be run at the higher voltage to selectively deposit the oxide of the second metal. If the voltage is then lowered, oxide of the first metal may also deposit on the oxide of the second metal and they may blend over time. FIG. 7 is a Scanning Electron Microscope (SEM) image of an anodic layer 100 formed of indium and tin oxides deposited out of an anode. The composition of the layer of FIG. 7 is shown in the Energy Dispersive X-ray (EDX) output of FIG. 8. An anodic layer formed of a metal oxide may also blend to some degree with the anode over time.

An Ellingham-Richardson diagram or similar tool may be used to identify metals that will deposit under particular conditions. It should be appreciated that while the present description focuses on voltage based control of metal oxide deposition, this is because it is a relatively easy parameter to control. As illustrated in the aforementioned Ellingham-Richardson diagrams, the temperature, oxygen partial pressure, ratio of carbon dioxide to carbon monoxide, and ratio of water to hydrogen may also affect whether a metal oxidizes. Accordingly, one or more of these variables may also be manipulated to control oxidation of anodic metals.

Example embodiments where a metal alloyed with the anode may preferentially form a metal oxide anodic layer on the electrolyte include indium, iron, cobalt, yttrium, calcium, magnesium, chromium, lanthanum, gadolinium, samarium, gallium, aluminum, titanium, scandium, beryllium and cerium in tin anodes. Preferably, the metal oxide anodic layer is relatively highly conductive, has a relatively high power density and is not harmful to the electrolyte, potentially reducing occlusion, corrosion and improving performance. In addition to these factors, the cost of the metal may be considered. For example, indium has a higher electrical conductivity compared to iron, but is typically more expensive. The mass fraction of the anode that is the metal intended to form the anodic layer may vary with the metal and the application, but, in one embodiment, is between about 0.1% and about 20%. In preferred embodiments, about 0.5 to about 2 weight percent of the anode is the metal intended to form the anodic layer. In embodiments where the anode comprises indium in tin, about 1 weight percent indium is preferred.

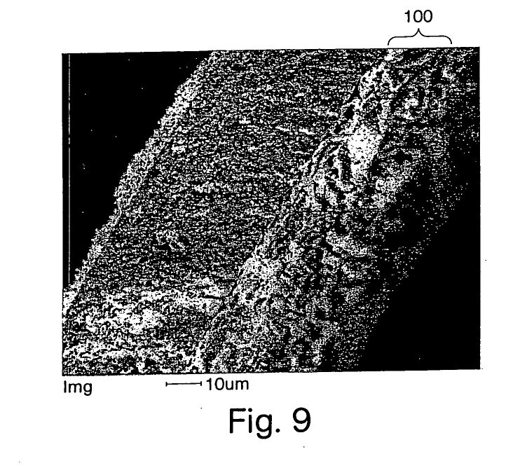

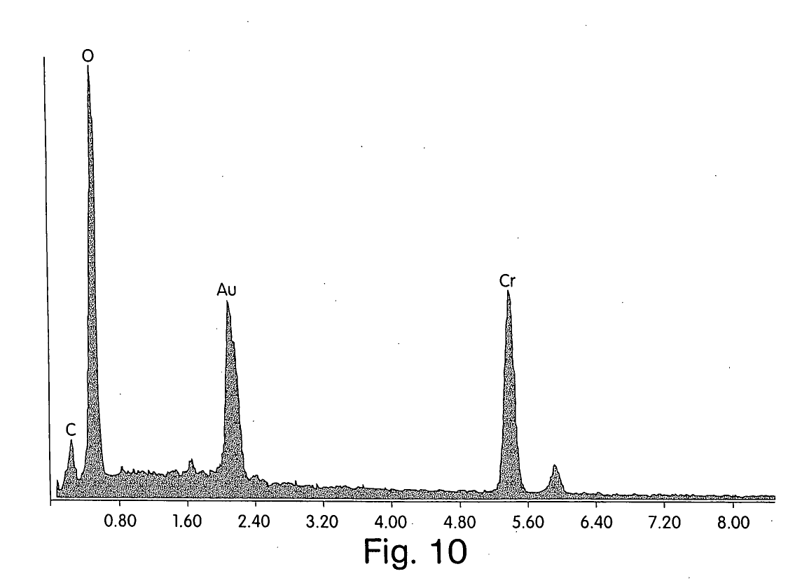

It should be appreciated that the method of depositing an anodic layer out an anode of the present invention is not limited to use in electrochemical devices. For example, this method may be used to form layers, such as metal oxide layers of Cr, Ce, Ga, Fe, Al, La, Sc, Y, Ti, Zr, Ba, Sr, Ca, Mg, V, Nb, Ta, W, Mo, Mn and lanthanides for other uses. It may be particularly suited to applications where relatively thin, dense layers of metal oxides are useful. For example, a pure, dense Cr oxide layer 100 was formed on YSZ by adding metal Cr to a tin anode to achieve 0.05 weight percent Cr in the anode. After the fuel cell reached 1000° C. an electric load was applied. A dense, pure Cr oxide layer about 10-15 microns thick was formed on the electrolyte as evidenced by the SEM and EDX analysis of FIGS. 9 and 10.

In other embodiments of the invention, it may be possible to apply the anodic layer to the electrolyte before assembling it into an electrochemical device. In one such embodiment, the anodic layer may be painted or dip-coated onto the electrolyte. Depending on the technique, it may be desired to paint or dip coat the anodic layer onto the electrolyte prior to sintering or after sintering. To render the material for the anodic layer able to be painted or dip coated, it may be desired to form a slurry, solution, or the like, of the material. One of skill in the art is able to identify materials suitable for rendering a particular material able to be painted or dip coated. Where the anodic layer is applied first, any organic materials used to render it able to be painted or dip coated may be burnt out as part of the sintering process.

In the above-described embodiments where the anodic layer is formed as pores in a portion of the electrolyte or other monolith, the anodic layer may be formed prior to assembling the electrolyte into an electrochemical device. For example, the electrolyte may be formed with a porous portion and the porous portion may subsequently have an anodic material introduced therein. Pores may be introduced into a portion of a ceramic electrolyte or monolith by introducing a pore forming material, such as graphite powder, into the green ceramic. Typically, the pore forming material is selected to burn out during the sintering process, leaving pores in the ceramic. An anodic material may be introduced into the pores by a variety of methods, such as spraying and painting. Anodic material may be rendered able to be sprayed or painted as described above.

### EXAMPLES

### Example 1

To demonstrate the feasibility of preparing an ITO (In₂O₃.SnO₂) layer on an electrolyte, three different methods were tested. In the first method, an In₂O₃—SnO₂ layer was formed in situ. A metallic mixture of In—Sn was charged into a fuel cell to serve as the anode. When the fuel cell reached 800-1000° C., a controlled load was applied (drawing electric current at a specific Open Circuit Voltage, 0.80-0.89V). A layer of In₂O₃—SnO₂ was thus formed on the surface of the electrolyte.

Various metallic mixtures of Sn and In having compositions of 80 to 99.9 weight percent (wt. %) Sn and 10 to 0.1 wt. % In were tested. Each mixture was put into a solid YSZ electrolyte fuel cell to serve as a liquid alloy anode. When the cell was heated to 800-1000° C., a load was applied in order to keep the open circuit voltage between 0.85 and 0.89 V. This open circuit voltage of 0.85 to 0.89 V was high enough to prevent SnO₂ formation, but was suitable for allowing formation of an In₂O₃ layer. At these potentials, the In₂O₃ was formed first at the interface between the solid electrolyte and the liquid anode. Subsequently, an open circuit voltage of 0.81 V or lower was applied, resulting in the formation of SnO₂ on the top of In₂O₃ layer. By controlling the open circuit voltage, a co-precipitation of In₂O₃—SnO₂ was achieved. Furthermore, at temperatures as high as 1000° C., the diffusion of SnO₂ and In₂O₃ into each other was observed. A solid ITO (In₂O₃.SnO₂) layer was formed on the surface of the electrolyte, demonstrating the feasibility of this method.

In one particular test according to the method of this example, a single fuel cell was employed. The electrolyte was made of YSZ with a thickness of 120 μm. The cathode was made of a porous LSM (La_{0.8}Sr_{0.2}MnO₃) layer of a thickness of 700 microns. Hydrogen or argon was introduced into the fuel cell through an Al₂O₃ tube (0.12 cm outer diameter and 0.08 cm inner diameter) from the top of the cell. Shots of Sn metal totaling 28 grams and shots of In metal totaling 0.28 gram were introduced into the cell as the anode. The cathode current collector was made of Pt wire of a diameter of 2.0 mm and a length of 15 cm. The anode current collector was made of a graphite rod or a Ni rod of diameter of 2.0 mm and a length of 21 cm which was surrounded by a ceramic (La_{0.8}Ca_{0.2}CrO₃) jacket.

The fuel cell device was placed into a furnace and was heated. When the temperature of the cell reached 1000° C., the cell showed an open circuit voltage of 1.06 V with a hydrogen flow of 10 cc/min. An electric load was then applied to keep the open circuit voltage between 0.85 and 0.89 V for 24 hours. After the 24 hours, an electric current of 2 A was drawn from the fuel cell device. With this current, the cell's load voltage reached 0.7 V. After 4 days running at a power output of 1.4 W with a hydrogen flow of 30 cc/min, the cell was examined for In₂O₃—SnO₂ layer formation by Scanning Electron Microscope (SEM) with an Energy Dispersive X-ray (EDX) instrument (EDAX Inc. of Mahwah, N.J.). It was found that a In₂O₃—SnO₂ layer of about 10 micron thickness with an In₂O₃ concentration of about 10-30% was formed on the surface of the electrolyte YSZ.

In another example employing an identical single fuel cell made of YSZ and LSM, shots of tin metal totaling 25.2 grams and shots of indium metal totaling 2.8 grams were introduced into the cell as the anode. The cell was placed into an electric furnace and was heated. When the cell reached temperature of 1,000 degrees C., an electric load was applied to maintain the load voltage between 0.85 to 0.89 V for 24 hours. Hydrogen flow was set at 18 ml/min. An electric load of 1.0 amp was then applied, which subsequently brought down the load voltage to 0.79 V. The cell was run for 15 days continuously at a power output of 0.79 watt and at a fuel utilization of 38.7%. Subsequent analysis conducted by SEM and EDX indicated that crystals formed on the electrolyte YSZ surface had an indium oxide concentration of about 60-80% by weight with a balance of tin oxide.

In the second method, an In₂O₃—SnO₂ layer was formed on the electrolyte ex-situ. A blend of 45 grams of indium oxide powder and 5 grams of tin oxide powder were mixed with 30 ml alcohol solvent (IPA, isopropyl alcohol), 4 grams binder (PVB, Poly Vinyl Butyral), 2.5 grams plasticizer (BBP, Butyl Benzyl Phthalate), and 0.5 grams dispersant (menhaden fish oil) to form a slurry. The slurry viscosity was adjusted to 1,500-2,500 cP by controlling the solvent amount. The slurry was painted on the surface of an electrolyte substrate of YSZ. This coated layer had a thickness of 10-20 μm and was allowed to dry in the air. The electrolyte with coating was heated according to the following heating program: ambient temperature to 400° C. degree at 0.5° C./minute, holding at 400° C. for 2 hours to burn out organic matter. The electrolyte and coating was then immediately (without cooling first) sintered by heating to 1200° C. at a heating ramp of 1.0° C./minute, holding at 1200° C. degree for 2 hours, and then cooling down to ambient at 1.0° C./minute. After sintering, an In₂O₃—SnO₂ layer was observed on the YSZ electrolyte.

In the third method, an In₂O₃—SnO₂ layer is also formed on an electrolyte ex-situ. Indium and tin metallic-organic precursors (19 ml indium isopropoxide and 2 ml tin isopropoxide) were dissolved into an alcohol solvent (20 ml isopropanol) to form a coating solution. The liquid solution was painted on the surface of the anode side of the YSZ electrolyte substrate and allowed to dry in the air. The painting process was repeated a few times where necessary to ensure a thickness of 5-10 μm. The coated specimen was sintered to 1200° C. with a heating ramp from room temperature of 1.0° C./minute, holding at 1200° C. for 2 hours, and then cooling to room temperature at 1.0° C./minute. After sintering an In₂O₃—SnO₂ layer was observed on the YSZ electrolyte. This demonstrates the feasibility of preparing an ITO (In₂O₃.SnO₂) layer on an electrolyte.

### Example 2

In order to demonstrate the feasibility of preparing a NiO bi-layer on an electrolyte, such a layer was prepared as part of tape casting the electrolyte. 200 grams of Zirconia powder stabilized with 8 mol % yttria (Tosoh, Japan) was mixed with 120 ml solvent (an azeotropic mixture of ethanol and xylenes), 5 grams dispersant (menhaden fish oil), 8 grams plasticizer (butyl benzyl phthalate), 6 grams plasticizer (poly alkylene glycol) and 13 grams binder (poly vinyl butyral) to form slurries for tape casting. A tape caster with a doctor blade was used to produce green tapes.

A thin NiO bi-layer was formed by one of two methods. In the first method, a coating composition was prepared by dispersing 57 grams nickel oxide and 43 grams stabilized zirconia powder in 150 ml polymer/solvent (cellulose/terpineol) liquid vehicle and was painted on the green tape of electrolyte. The coated tape was allowed to dry and then co-fired at 1° C. per minute to 400° C. and held for 2 hours to burn out the polymer binder and finally heated to 1550° C. at a heating ramp of 2° C. per minute and held for 4 hours to sinter the bi-layer. The sample was cooled to ambient temperature at a rate of 3° C. per minute.

In the second method, the green tape of electrolyte was first heated at 1° C. per minute to 400° C. to burn out the polymer binder and then heated at 1150° C. at a heating ramp of 2° C. per minute and held for 4 hours to form a semi-fired porous substrate. The sample, was cooled to ambient temperature at a rate of 3° C. per minute. A thin layer of NiO/YSZ was then dip coated on the porous fired electrolyte by using a slurry prepared by dispersing 57 grams nickel oxide and 43 grams stabilized zirconia powder in 1 liter ethanol. Finally, the coated substrate was fired to 1600° C. at a heating ramp of 2° C. per minute to sinter the bi-layer and cooled to ambient temperature at a rate of 3° C. per minute. This demonstrates the feasibility of preparing a NiO bi-layer on an electrolyte.

### Example 3

To demonstrate the feasibility of preparation of a CeO₂ layer on an electrolyte, such a layer was prepared. The preparation was performed by making green tapes of YSZ and subsequently coating them with CeO₂. Two kinds of green tapes of zirconia powder stabilized with 8 mol % yttria (YSZ) were prepared for tape casting. The first was the same as described in Example 2. 200 grams of Zirconia powder stabilized with 8 mol % yttria (Tosoh, Japan) was mixed with 120 ml solvent (an azeotropic mixture of ethanol and xylenes), 5 grams dispersant (menhaden fish oil), 8 grams plasticizer (butyl benzyl phthalate), 6 grams plasticizer (poly alkylene glycol) and 13 grams binder (poly vinyl butyral) to form slurries for tape casting. A tape caster with a doctor blade was used to produce green tapes. The second green tape had 27 grams graphite powder as pore forming agent in addition to zirconia powder.

To form the bi-layer tape, a multiple tape casting technique was used in which the second layer was cast on top of the first green tape. The bi-layer tape was first heated at 1° C./minute to 400° C. and held for two hours in order to burn out the polymer binder, then heated to 600° C. and held for 2 hours to burn out the graphite, and finally heated at a rate of 2° C. per minute to 1600° C. and held for 4 hours. After sintering, a bi-layer structure with one thin porous zirconia layer on top of dense zirconia layer was obtained.

A solution of Ce(NO₃)₃ of 1 M concentration was sprayed to the top porous layer of the bi-layer structure, and then the bi-layer was fired in air at 1000° C. to form a CeO₂/YSZ thin layer on top of dense YSZ electrolyte. This demonstrates the feasibility of preparation of a CeO₂ layer on an electrolyte.

### Example 4

To demonstrate the feasibility of preparing a metal oxide layer on an electrolyte in situ according to one method of the invention, such a layer was prepared. A metallic mixture was placed into a solid YSZ electrolyte fuel cell to serve as a liquid anode. Shots of Sn metal totaling 29.9 grams and bits of Cr metal totaling 0.149 gram were introduced into the cell as the anode, resulting in a Cr concentration of about 0.5 wt. %. The electrolyte was made of YSZ with a thickness of 120 μm. The cathode was made of a porous LSM (La_{0.8}Sr_{0.2}MnO₃) layer of a thickness of 700 microns. The cathode current collector was made of Pt wire of a diameter of 2.0 mm and a length of 15 cm. The anode current collector was made of a graphite rod or a Ni rod of diameter of 2.0 mm and a length of 21 cm which was surrounded by a ceramic (La_{0.8}Ca_{0.2}CrO₃) jacket.

The fuel cell device was placed into a furnace and was heated. Hydrogen or argon was introduced into the fuel cell through an Al₂O₃ tube (0.12 cm outer diameter and 0.08 cm inner diameter) from the top of the cell. When the temperature of the cell reached 1000° C., the cell showed an open circuit voltage of 1.10 V with a hydrogen flow of 10 cc/min. AN electric load of 1.0 amp was then applied initially to keep the open circuit voltage above 0.81V to prevent SnO₂ formation, but it was found the at the load voltage decreased. Within 35 minutes, the current diminished to near zero. The load was then removed for 10 minutes. Because hydrogen flow remained on, chemical recharge occurred inside the cell. An electric load of 0.5 amp was then applied to the cell. After 2 hours, the cell was no longer able to maintain any current, due to the formation of highly resistive layer of Cr oxide formed on the electrolyte. The cell was examined for Cr oxide layer formation by Scanning Electron Microscope (SEM) with an Energy Dispersive X-ray (EDX) instrument (EDAX inc. of Mahwah, N.J.). It was found that a pure, dense Cr oxide layer of about 10-15 micron thickness was formed on the surface of the electrolyte.

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, or method described herein. In addition, any combination of two or more such features, systems or methods, provided that such features, systems, or methods are not mutually inconsistent, is included within the scope of the present invention.

1. An electrochemical device, comprising:
an anodic material positioned between an electrolyte and a liquid metal, wherein the liquid metal functions as an anode.

2. The electrochemical device of claim 1, comprising an anodic layer positioned between the electrolyte layer and the liquid metal, wherein the anodic layer comprises the anodic material.

3. The electrochemical device of claim 1, wherein the anodic material has an ionic conductivity of at least about 0.01 S/cm, at a temperature at which the device is operable.

4. The electrochemical device of claim 2, wherein the anodic layer has an electronic conductance greater than or equal to that of the electrolyte layer.

5. The electrochemical device of claim 4, wherein the electronic conductance of the anodic layer is at least about 0.001 S/cm, at a temperature at which the device is operable.

6. The electrochemical device of claim 2, wherein the anodic material is capable of transporting oxygen through an anodic layer/electrolyte interface.

7. The electrochemical device of claim 6, wherein a total oxygen flux through the anodic layer/electrolyte interface is at least about 1015 oxygens/s·cm2.

8. The electrochemical device of claim 2, wherein the anodic layer further comprises material not able to function as the anode.

9. The electrochemical device of claim 8, wherein the anodic layer comprises pores and the pores comprise anodic material.

10. The electrochemical device of claim 2, wherein the anodic layer comprises an oxide of the liquid metal.

11. The electrochemical device of claim 10, wherein the liquid metal comprises an alloy comprising a first metal and a second metal.

12. The electrochemical device of claim 11, wherein the anodic layer comprises an oxide of the first metal and an oxide of the second metal.

13. The electrochemical device of claim 12, wherein, in the liquid metal, the mass fraction of the first metal is greater than the mass fraction of the second metal and wherein, in the anodic layer, the mass fraction of the oxide of the second metal is greater than the mass fraction of the oxide of the first metal.

14. The electrochemical device of claim 13, wherein the second metal comprises about 0.1 to about 5% of the mass of the liquid metal.

15. The electrochemical device of claim 14, wherein the second metal comprises about 0.5 to about 2% of the mass of the liquid metal.

16. The electrochemical device of claim 13, wherein the first metal is selected from a group consisting of bismuth, lead, antimony and tin and the second metal is selected from the group consisting of indium, iron, cobalt, gallium, aluminum, calcium, magnesium, beryllium, scandium, barium, yttrium, zirconium, strontium, titanium, manganese, lanthanides and mixtures thereof.

17. An electrochemical device, comprising a catalyst positioned adjacent to an electrolyte layer, the catalyst further contacting a liquid metal.

18. The electrochemical device of claim 17, wherein the catalyst comprises a layer comprising catalytic material.

19. The electrochemical device of claim 17, wherein the catalyst comprises localized sites of catalytic material distributed on the electrolyte layer.

20. An anode, comprising a liquid metal positioned adjacent a ceramic having an ionic conductivity of at least about 0.01 S/cm and an electrical conductance of at least about 0.001 S/cm.

21. A method of forming a layer in an electrochemical device, comprising:
providing an anode comprising a liquid first metal such that it is in contact with an electrolyte; and
depositing a portion of the first metal on the electrolyte as a first metal oxide.

22. The method of claim 21, wherein depositing a portion of the first metal further comprises maintaining a first voltage in the electrochemical device.

23. The method of claim 21, wherein the first metal is selected from a group consisting of tin, antimony, lead, bismuth and mixtures thereof.

24. The method of claim 21, further comprising
providing a liquid second metal to the anode; and
depositing a portion of the second metal on the electrolyte as a second metal oxide.

25. The method of claim 24, wherein the second metal is selected from a group consisting of indium, iron, cobalt, chromium, gallium, aluminum, calcium, magnesium, beryllium, scandium, barium, yttrium, zirconium, strontium, titanium, manganese, lanthanides, and mixtures thereof.

26. The method of claim 24, wherein depositing the portion of the first metal comprises maintaining a first voltage in the electrochemical device and depositing the portion of the second metal comprises maintaining a second voltage in the electrochemical device.

27. The method of claim 26, wherein the portion of the second metal is deposited before the portion of the first metal is deposited.

28. The method of claim 21, wherein the electrochemical device is a solid oxide fuel cell.

29. An electrochemical device, comprising:
an anode; and
a current collector comprising a liquid metal in electronic communication with the anode.

30. The electrochemical device of claim 24, wherein the anode comprises the liquid metal.

31. An electrochemical device, comprising:
an anodic layer positioned between an electrolyte and a liquid metal, wherein the anodic layer comprises a material capable of transporting oxygen through an anodic layer/electrolyte interface.

32. An electrochemical device, comprising:
an electric circuit comprising a liquid metal; and
an anodic material positioned between an electrolyte and the liquid metal.
